(19) United States
(12) Patent Application Publication
(10) Pub. No.: US 2003/0063898 A1
(43) Pub. Date: Apr. 3, 2003

(54) Disk player and television receiver incorporating same

(75) Inventors: Koichi Nakao, Osaka (JP); Yoshiaki Kanamori, Osaka (JP)

Correspondence Address: ARMSTRONG,WESTERMAN & HATTORI, LLP, 1725 K STREET, NW, SUITE 1000, WASHINGTON, DC, 20006, US

(73) Assignee: SANYO ELECTRIC CO., LTD, Moriguchi-shi (JP)

(21) Appl. No.: 10/259,636

(22) Filed: Sep. 30, 2002

(30) Foreign Application Priority Data
Oct. 1, 2001 (JP) 2001-305880
Oct. 1, 2001 (JP) 2001-305881
Oct. 1, 2001 (JP) 2001-305882
Oct. 1, 2001 (JP) 2001-305883

(51) Int. Cl. H04N 5/781; H04N 5/225

(52) U.S. Cl. 386/125; 386/117

(57) ABSTRACT

The invention provides a disk player which comprises a turntable having a horizontal rotation spindle, a signal reproduction unit for reproducing signals from a disk 12 placed on the turntable, a holder 3 movable toward or away from the turntable while holding therein the disk 12 as inserted through a disk inlet, a holder drive mechanism for reciprocatingly driving the holder 3, a lifter 5 disposed inside the holder 3 and adapted to support the disk 12 in a vertical posture, a lifter drive mechanism for upwardly or downwardly driving the lifter 5 inside the holder 3, and a prime mover mechanism for transmitting power to the holder drive mechanism and to the lifter drive mechanism.

### FIELD OF THE INVENTION

The present invention relates to DVD players or like disk players and to television receivers having the disk player incorporated therein.

### BACKGROUND OF THE INVENTION

Generally with television receivers having a disk player incorporated therein, the disk player is disposed inside the cabinet of the receiver main body having a display screen or inside the cabinet of a speaker device disposed at one side of the receiver main body and has a disk tray which is movable outward from and retractable into the front panel of the cabinet. A disk is placed in a horizontal posture on the tray, whereby the disk is sent to a signal reproduction unit disposed in the rear of the front panel.

In recent years, thin television receivers having a liquid-crystal display or plasma display have been developed. When the conventional disk player is incorporated into such a thin television receiver, the disk is placed in a horizontal posture into the cabinet, so that the depthwise dimension of the television receiver cabinet is restricted by the diameter of the disk. Accordingly, a disk player has been proposed which is adapted to transport the disk in a vertical posture to a record reproduction position.

In the case of the proposed disk player, for example, a holder for holding a disk in a vertical posture is moved horizontally toward a record reproduction mechanism, the disk is then placed on a turntable by driving the turntable or the holder, and a chuck pulley disposed as opposed to the turntable is moved toward the disk to chuck the disk as placed on the turntable.

This disk player has a disk inlet formed in the top wall of the cabinet thereof, so that when to be incorporated into a television receiver, the disk player needs to be disposed in the uppermost portion of the receiver cabinet. Thus, the player has the problem of being limited in position since the player can not be disposed in the central portion or a lower portion of the cabinet.

With the disk player described, loading of the disk is started by pushing down the disk inserted in a vertical posture into the disk inlet. However, the player has the problem that if the disk is pushed down to a great extent with an excessive force, the disk will be deformed or the disk loading mechanism will be damaged.

Further with a disk loading mechanism wherein a disk holder is supported on a fixed chassis and reciprocatingly movable horizontally relative to the chassis, and the disk as placed in the holder is transported to a signal reproduction unit by driving the holder, a lifter is provided inside the holder for ejecting the disk upward from the disk inlet. In this case, the lifter is movable horizontally along with the holder, while a lifter drive member for driving the lifter upward or downward is provided on the chassis and allowed to move only upward or downward, so that the arrangement has the problem that means for connecting the lifter drive member to the lifter becomes complex.

The disk chucking mechanism for conventional disk players requires a mechanism for driving the chuck pulley toward or away from the disk, in addition to a mechanism for reciprocatingly driving the turntable or the holder. Especially the chuck pulley drive mechanism comprises many components. This entails the problem that the disk chucking mechanism is complex in construction.

The disk chucking mechanism for conventional disk players has another problem. It is difficult to engage the chuck pulley with the turntable, with the axis of rotation of the chuck pulley aligned with the axis of rotation of the turn table, by moving the chuck pulley disposed as opposed to the turntable toward the disk to chuck the disk on the turntable. If the chuck pulley is engaged with the turntable, with the axes of rotation out of alignment with each other, unreliable engagement will result.

### SUMMARY OF THE INVENTION

A first object of the present invention is to provide a disk player which can be incorporated into a television receiver without imposing any limitation on the depthwise dimension of the cabinet by the diameter of the disk and which can be disposed inside the cabinet of the receiver without being restricted in position.

To fulfill the first object, the invention provides a disk player which comprises:

a turntable 14 having a horizontal rotation spindle,

a signal reproduction unit 15 for reproducing signals from a disk 12 as placed in a vertical posture on the turntable 14,

a holder 3 having an upwardly open disk inlet 13 and movable toward or away from the turntable 14 while holding therein the disk 12 inserted in a vertical posture through the inlet 13,

a holder drive mechanism for reciprocatingly driving the holder 3 toward and away from the turntable;

a lifter 5 disposed inside the holder 3 and adapted to support the disk 12 in the vertical posture as inserted through the inlet 13,

a lifter drive mechanism for upwardly or downwardly driving the lifter 5 inside the holder 3, and

a prime mover mechanism 20 including a motor 21 as a power source for transmitting power to the holder drive mechanism and to the lifter drive mechanism.

With the disk player of the invention, the disk 12 is inserted in a vertical posture into the disk inlet 13 of the holder 13, with the holder 3 in an open position that is remotest from the turntable 14 and with the lifter 5 in the uppermost position, whereby the disk 12 is supported by the lifter 5. In this state, the lifter drive mechanism operates first to lower the lifter 5, and the disk 12 is accommodated in the holder 3 with this movement.

The holder drive mechanism then operates to move the holder 3 toward the turntable 14, and the disk 12 in the holder 3 is eventually placed on the turntable 14. The lifter 5 further descends slightly away from the disk 12, whereby the disk 12 is rendered free to rotate. The turntable 14 is rotatingly driven in this state, whereby the disk 12 is rotated for the signal reproduction unit 15 to reproduce signals from the disk 12.

The disk player of the invention can be incorporated into a television receiver without being limited in its position inside the cabinet, while the disk can be placed into the cabinet in a vertical posture in parallel to the front panel. The depthwise dimension of the cabinet is therefore not limited by the diameter of the disk.

When incorporated into the television receiver, the disk player 11 of the invention is installed therein, as exposed from the front panel 17 of the receiver cabinet 16. The turntable 14 rotatingly drives the disk 12 in the vertical position in parallel to the front panel 17. The holder 3 is reciprocatingly horizontally movable between an open position where the disk inlet 13 is advanced forward beyond the front panel 17 and a closed position where the inlet 13 is retracted rearwardly of the front panel 17.

With the television receiver of the invention, the holder 3 is reciprocatingly movable forward or rearward, whereby the disk inlet 13 is advanced forward beyond the front panel 17 or retracted rearwardly of the panel 17. Accordingly, other mechanisms, if provided above the disk player 11, will cause no trouble to the operation of the player 11, with the result that the disk player 11 can be disposed in the central portion or lower portion inside the cabinet 16.

A second object of the present invention is to provide a disk player of the type wherein the disk is transported in a vertical upright posture to a record reproduction position, the disk being loadable as inserted in a vertical posture through a disk inlet without being deformed or without causing damage to a lifter drive mechanism inside a holder even if the disk is pushed down to a great extent with an excessive force, the player having a lifter movable upward or downward by a simplified drive mechanism.

To fulfill the second object, the present invention provides a disk player which comprises:

a chassis 2 provided with a turntable 14 and a signal reproduction unit 15,

a holder 3 having an upwardly open disk inlet 13 and reciprocatingly horizontally movably supported by the chassis 2, the holder 3 being movable toward or away from the turntable 14,

a holder drive mechanism for reciprocatingly driving the holder 3 toward and away from the turntable;

a lifter 5 disposed inside the holder 3 upwardly or downwardly movably and adapted to support the disk 12 in a vertical posture as inserted through the inlet 13, and

a lifter drive mechanism for upwardly or downwardly driving the lifter 5 inside the holder 3, the lifter drive mechanism comprising a lifter drive slide 6 upwardly or downwardly drivable by a prime mover mechanism 20 provided on the chassis 2, and a spring 60 connecting an end portion of the lifter drive slide 6 to an end portion of the lifter 5.

With the disk player of the invention, the disk 12 is inserted in a vertical posture into the disk inlet 13 of the holder 13, with the holder 3 in an open position that is remotest from the turntable 14 and with the lifter 5 in the uppermost position, whereby the disk 12 is supported by the lifter 5.

When the disk 12 is pushed down in this state, the prime mover mechanism 20 is initiated into operation to drive the lifter drive slide 6 downward. Since the lifter drive slide 6 is connected to the lifter 5 by the spring 60, the lifter 5 moves down with the slide 6, and the disk 12 is placed into the holder 3 with this movement.

Even if the disk 12 is pushed down with an excessive force, the connecting spring 60 stretches, permitting the lifter 5 to move down relative to the slide 6, and the spring 60 absorbs the excessive force acting on the lifter 5. This obviates the likelihood of the disk 12 deforming or the lifter drive mechanism being damaged.

Next, the holder drive mechanism operates to move the holder 3 toward the turntable 14, and the disk 12 in the holder 3 is eventually placed on the turntable 14. The holder 3 moves horizontally to thereby move the lifter 5 inside the holder 3 also horizontally, while the lifter drive slide 6 is provided on the chassis 2 and is allowed to move only downward or upward, whereas since the lifter 5 and the slide 6 are merely connected together by the spring 60, the spring 60 stretches, permitting the lifter 5 to move horizontally relative to the slide 6.

The lifter 5 thereafter slightly descends away from the disk 12, whereby the disk 12 is rendered free to rotate. The turntable 14 is rotatingly driven in this state, whereby the disk 12 is rotated for the signal reproduction unit 15 to reproduce signals from the disk 12.

Even if the disk as inserted in a vertical posture into the inlet of the holder is pushed down to a great extent with an excessive force, there is no likelihood that the disk will be deformed or the lifter drive mechanism will be damaged. Moreover, the lifter drive mechanism can be provided by a simple construction, i.e., by connecting the lifter and the lifter drive slide to each other by a connecting spring.

A third object of the present invention is to provide a disk chucking mechanism of simple construction for disk players.

To fulfill the third object, the present invention provides a disk chucking mechanism for use in a disk player which mechanism comprises:

a holder 3 movable toward or away from a turntable 14 relative thereto while holding a disk 12 therein,

a chuck pulley assembly 9 provided on, and inserted through an opening 34 in, the holder 3 for holding the disk 12 between the assembly and the turntable 14, and

a metal member attached to the holder 3 and opposed to the chuck pulley assembly 9.

The chuck pulley assembly 9 comprises a resin chuck pulley 91 engageable with the turntable 14, a metal chuck disk 92 opposed to the metal member and a magnet 93 provided between the chuck pulley 91 and the chuck disk 92, the chuck disk 92 having a plurality of through holes 94 formed therein for causing lines of magnetic force emanating from the magnet 93 to leak therethrough toward the metal member.

In chucking the disk, the holder 3 approaches the turntable 14 relative thereto, whereby the disk 12 held in the holder 3 is placed on the turntable 14. Further the approach of the chuck pulley assembly 9 attached to the holder 3 to the turntable 14 permits the magnetic force of the magnet 93 of the assembly 9 to act intensely on the turntable 14, whereby the assembly 9 is attracted to the turntable 14. Consequently, the disk 12 is chucked as placed on the turntable 14.

The lines of magnetic force emanating from the magnet 93 leak through the holes 94 of the chuck disk 92 of the assembly 9, acting also on the metal member on the holder 3, whereas the magnetic force of the magnet 93 acts more intensely on the turntable 14 than on the metal member since the distance between the magnet 93 and the turntable 14 is small.

In releasing the disk from the chuck, the holder 3 moves away from the turntable 14 relative thereto, whereby the disk 12 in the holder 3 is moved away from the turntable 14. Further the chuck pulley assembly 9 attached to the holder 3 is moved away from the turntable 14, whereby the attraction by the turntable 14 is diminished, permitting the lines of magnetic force leaking though the holes 94 in the chuck disk 92 to act on the metal member on the holder 3 to produce a predominant attraction and allowing the assembly 9 to be attracted to the metal member. As a result, the disk 12 is moved away from the turntable 14, and the assembly 9 is held away from the disk 12.

The holder 3 is merely reciprocatingly driven toward and away from the turntable 14 relative thereto, whereby the disk 12 held in the holder 3 can be chucked and released. The disk chucking mechanism of the invention is therefore simple in construction. The attraction exerted by the metal member of the holder 3 is adjustable by varying the inside diameter and the number of through holes 94 to be formed in the chuck disk 92. This serves to reduce the noise involved in releasing the disk from the chuck, hence outstanding advantages.

A fourth object of the present invention is to provide a disk chucking mechanism for use in a disk player which mechanism comprises a chuck pulley engageable with the turntable, with the axis of rotation of the chuck pulley in alignment with the axis of rotation of the turntable.

To fulfill the fourth object, the present invention provides a disk chucking mechanism for use in a disk player which mechanism comprises:

a holder 3 movable toward or away from a turntable 14 relative thereto while holding a disk 12 therein, and

a chuck pulley 91 provided on, and inserted through an opening 34 in, the holder 3 for holding the disk 12 between the pulley and the turntable 14,

specified play being provided between an inner periphery of the holder 3 defining the opening 34 and an outer periphery of the chuck pulley 91 radially of the pulley 91 and with respect to the direction of axis of rotation thereof, the chuck pulley 91 having guide faces slidable in contact with the opening-defining inner periphery of the holder 3 when moved toward the holder 3 to align a center axis of the pulley 91 with a center axis of the turntable 14.

The holder 3 is driven away from the turntable 14, with the chuck pulley 91 engaged with the turntable 14 and with the disk 12 inside the holder 3 placed on the turntable 14, whereby the chuck pulley 91 is moved away from the turntable 14 toward the holder 3 first. This brings the guide faces of the chuck pulley 91 into sliding contact with the inner periphery of the holder 3 defining the opening 34. The aligning action of the guide faces aligns the axis of rotation of the pulley 91 with the axis of rotation of the turntable 14. The holder 3 further moves away from the turntable 14, whereby the disk 12 is released from the turntable 14.

Subsequently in chucking the disk 12, the holder 3 is driven toward the turntable 14, whereupon the disk 12 is first placed on the turntable 14, and the chuck pulley 91 is then attracted by the turntable 14. With the chuck pulley 91 held coaxial with the turntable 14, the pulley 91 moves toward the turntable 14 axially thereof into engagement therewith without coming into sliding contact with the opening-defining inner periphery of the holder 3.

With the disk chucking mechanism of the invention, the chuck pulley can be engaged with the turntable, with the axis of rotation of the chuck pulley in alignment with the axis of rotation of the turntable. This realizes reliable engagement.

### BRIEF DESCRIPTION OF THE DRAWINGS

FIGS. 1(a) and 1(b) are perspective views of a television receiver having incorporated therein a disk player according to the invention, the views showing the movement of a holder into or out of the receiver;

FIG. 2 is a perspective view showing the disk player of the invention with the holder in a closed position;

FIG. 3 is a perspective view showing the disk player of the invention with the holder in an open position;

FIG. 4 is a perspective view showing the disk player in the same state as above, with the holder omitted;

FIG. 5 is a perspective view of the disk player as it is seen from behind;

FIG. 6 is a perspective view showing components arranged on a chassis;

FIG. 7 is a perspective view showing a cam slide in engagement with the holder;

FIG. 8 is a perspective view showing a power transmission route from a cam gear to the cam slide;

FIG. 9 is a perspective view showing a power transmission route from a lifter drive lever on the chassis to a lifter;

FIG. 10 is a perspective view showing a coupling structure between the cam gear and the lifter;

FIG. 11 is a perspective view showing a power transmission route from a prime mover mechanism to the lifter;

FIG. 12 is a perspective view of the chassis;

FIG. 13 is a perspective view of the holder;

FIG. 14 is a front view of the cam gear;

FIG. 15 is a perspective view of a lifter drive slide;

FIG. 16 is a perspective view of the lifter;

FIG. 17 is a perspective view of a holder drive slide;

FIG. 18 is a perspective view of the cam slide;

FIGS. 19(a) and 19(b) are sectional views of a chuck pulley assembly;

FIG. 20 is a perspective view of an iron plate and the chuck pulley assembly;

FIG. 21 is an exploded perspective view of the chuck pulley assembly;

FIGS. 22(a), 22(b) and 22(c) are a series of sectional views showing a chuck release movement;

FIGS. 23(a), 23(b) and 23(c) are a set of views showing the holder as closed;

FIGS. 24(a), 24(b) and 24(c) are a set of views showing the holder as opened;

FIG. 25 is a perspective view showing an eject state of the disk player;

FIG. 26 is a perspective view showing the disk player with the lifter in the course of descent;

FIG. 27 is a perspective view showing the disk player with the holder in the course of retraction;

FIG. 28 is a perspective view showing the disk player with the holder closed; and

FIG. 29 is a perspective view showing the disk player during playing.

### DETAILED DESCRIPTION OF EMBODIMENT

An embodiment of the invention will be described below in detail with reference to the drawings.

Overall Construction

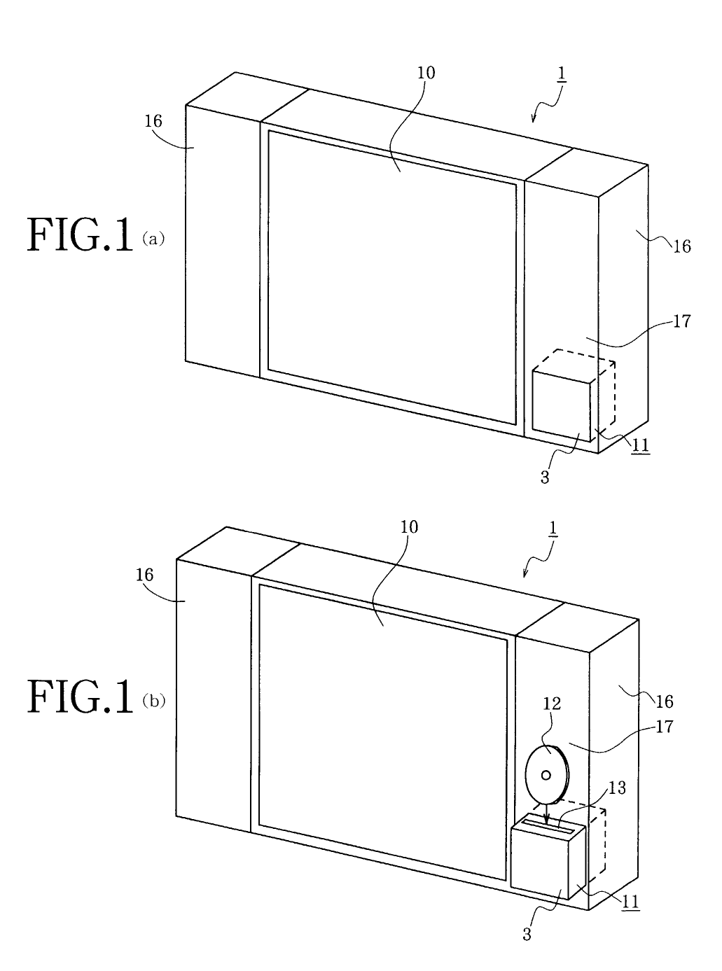

FIGS. 1(a) and 1(b) show a thin television receiver 1 having incorporated therein a disk player 11 according to the invention. The receiver 1 comprises a main body having a screen 10 and a pair of speaker devices arranged at opposite sides of the main body. Disposed inside a cabinet 16 of one of the speaker devices is the disk player 11 of the invention as exposed from a lower portion of a front panel 17 of the cabinet.

The disk player 11 has a holder 3 for holding a disk 12. The holder 3 is reciprocatingly movable forward and rearward between an open position in which the holder is projected forward beyond the front panel 17 as shown in FIG. 1(b) and a closed position in which the holder is retracted rearwardly of the front panel 17 as seen in FIG. 1(a).

When the holder 3 is moved to the open position, a disk inlet 13 formed in the upper wall of the holder 3 is exposed as shown in FIG. 1(b), permitting the insertion of the disk 12 thereinto. The movement of the holder 3 loaded with the disk 12 to the closed position shown in FIG. 1(a) places the disk 12 in the holder 3 on a turntable 14 for the reproduction of signals by a signal reproduction unit 15.

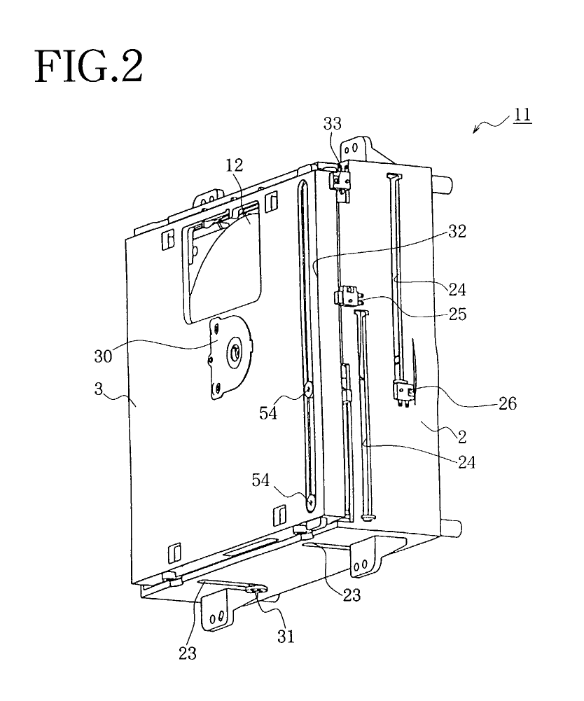

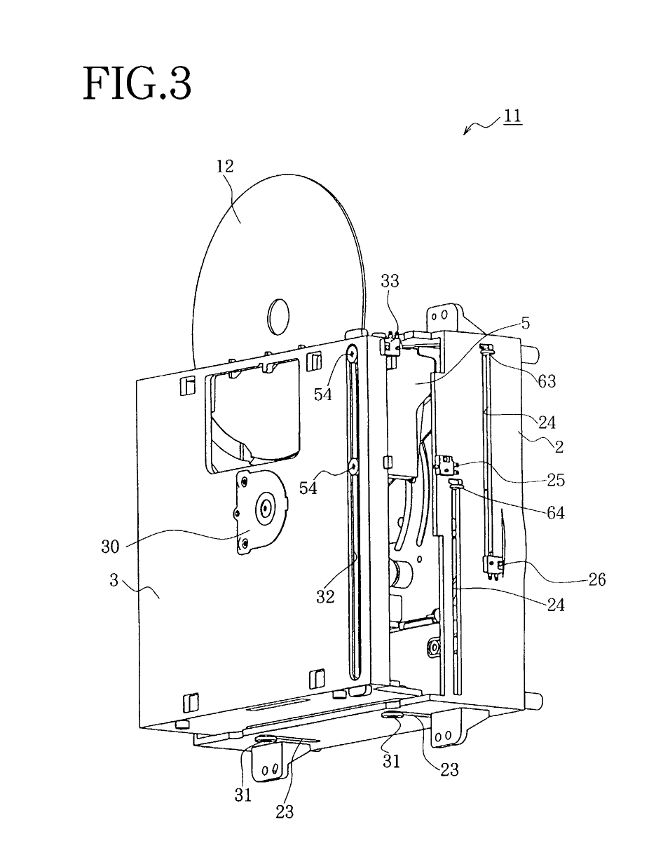

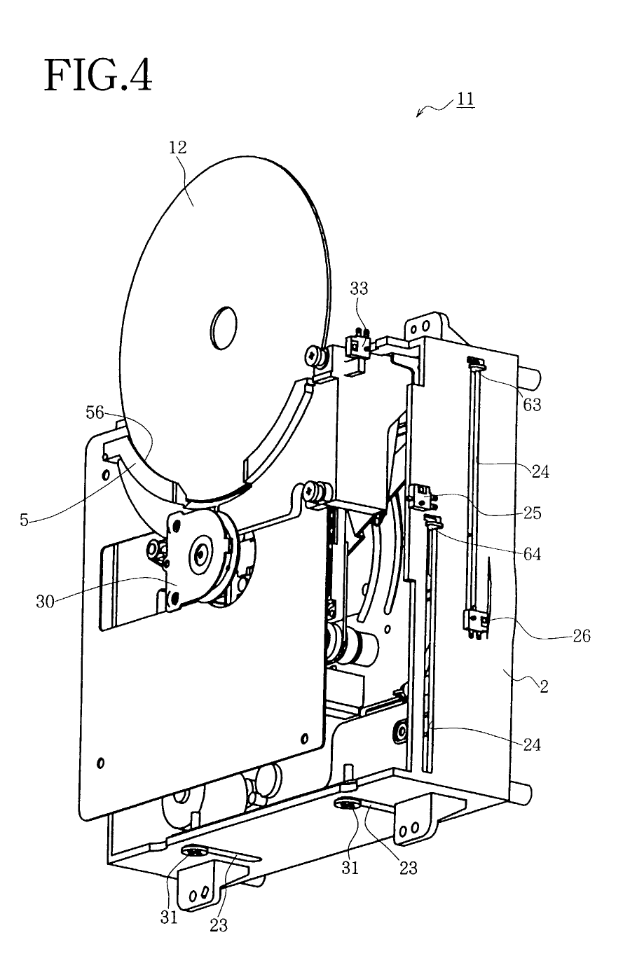

As shown in FIGS. 2 and 3, the disk player 11 has a small boxlike chassis 2 with a small depth, and the holder 3 is mounted on the chassis 2 reciprocatingly forwardly and rearwardly movably. Upwardly and downwardly movably disposed inside the holder 3 is a lifter 5 for supporting the disk 12 in a vertical posture as shown in FIG. 4. The lifter 5 has a circular-arc disk support 56 as shown in FIG. 16.

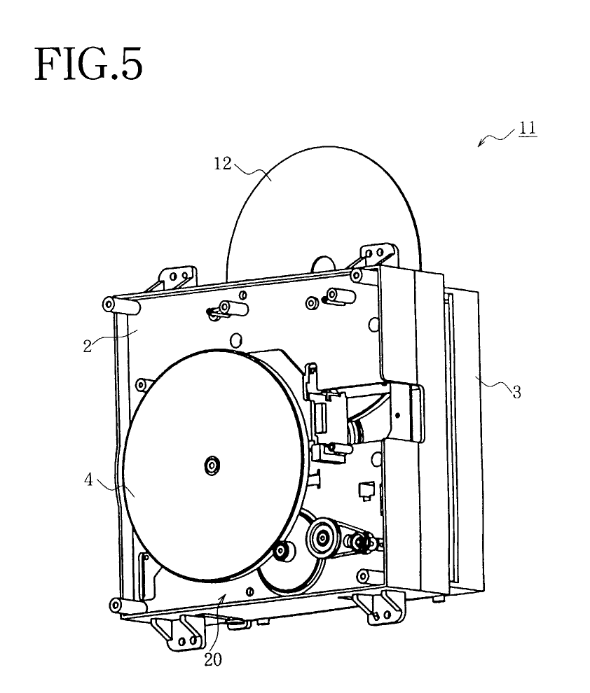

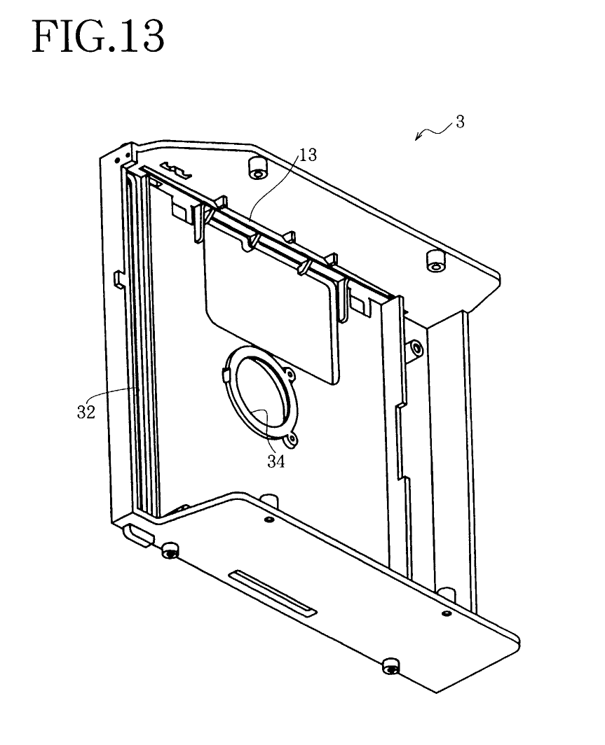

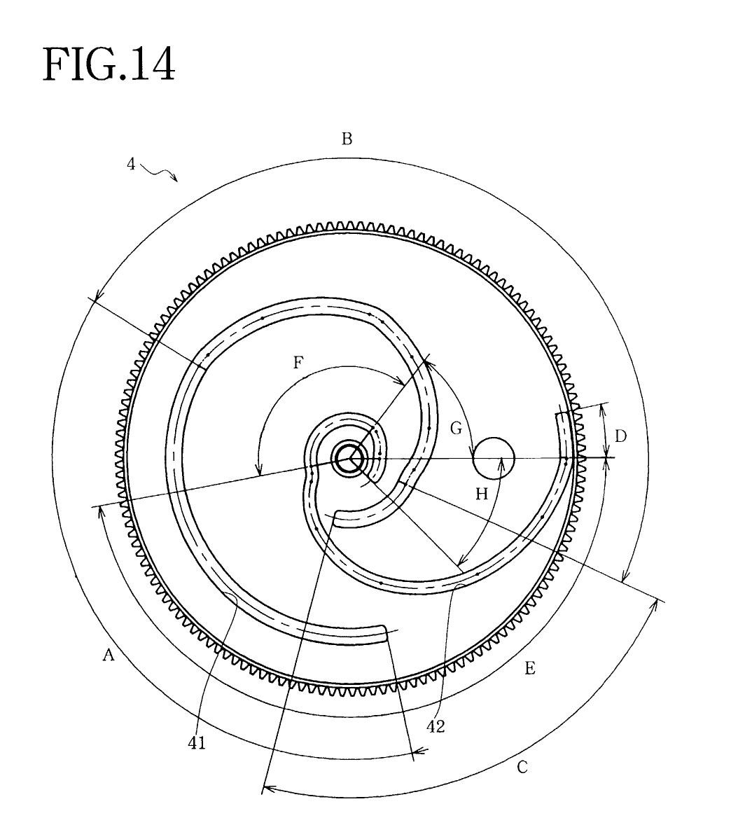

Provided on the rear side of the chassis 2 is a prime mover mechanism 20 for drivingly rotating a cam gear 4 by a motor (not shown) as a power source as shown in FIG. 5. Two spiral cam grooves 41, 42 shown in FIG. 14 are formed in the surface of the cam gear 4 which surface is opposed to the chassis 2. The holder 3 is reciprocatingly driven and the lifter 5 is driven upward and downward by the cam action of the two cam grooves 41, 42 as will be described later.

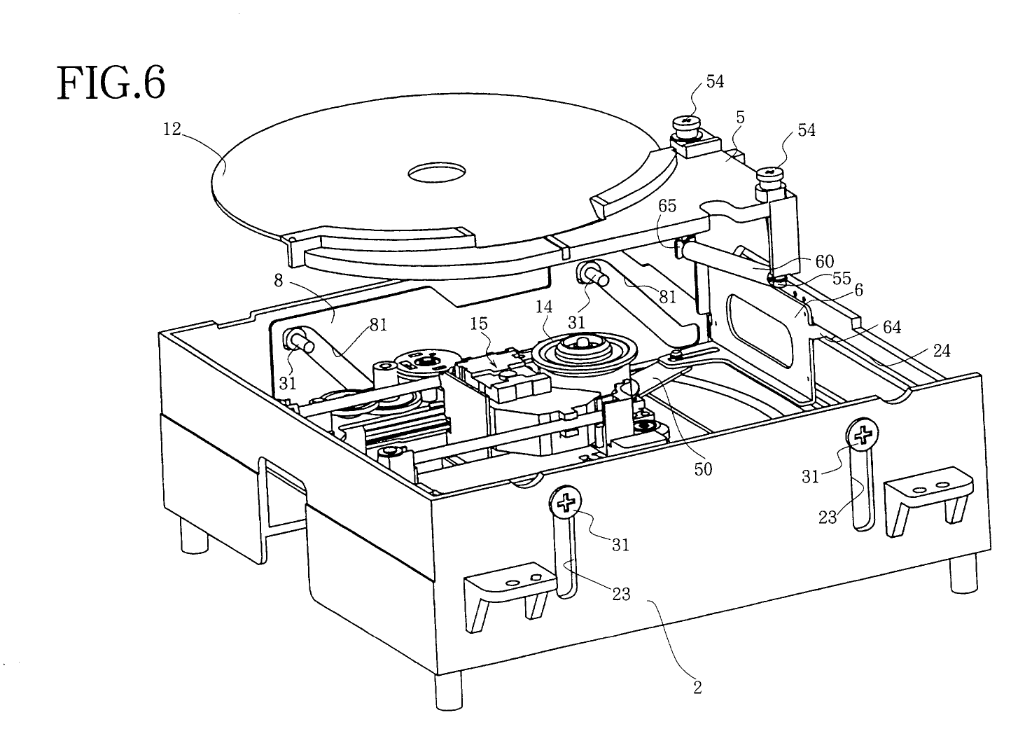

With reference to FIG. 6, mounted on the chassis 2 are the turntable 14 for drivingly rotating the disk 12, and the signal reproduction unit 15 for reproducing signals from the disk 12 as placed on the turntable 14.

Holder Drive Mechanism

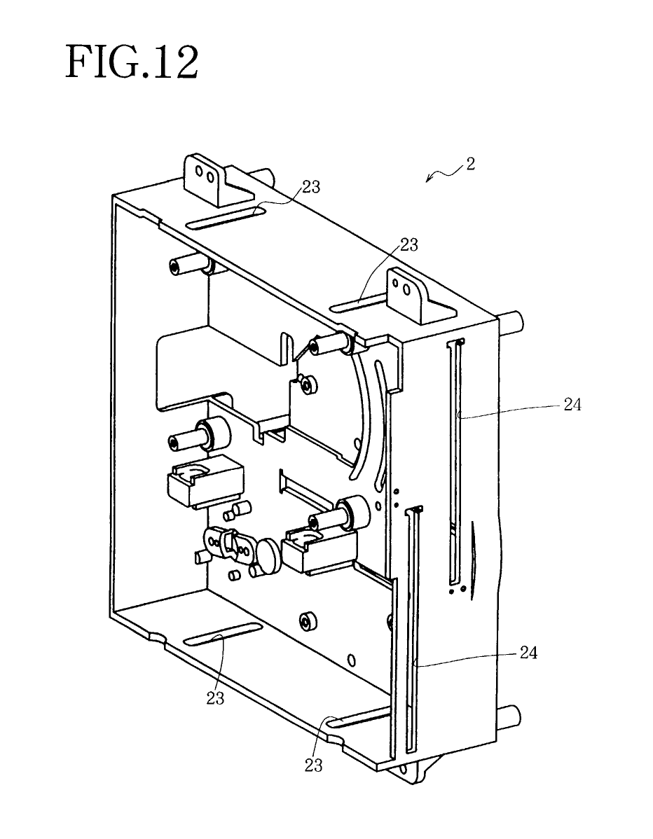

With reference to FIG. 12, the chassis 2 has an upper wall and a lower wall, each of which is provided with two holder guide slots 23, 23 extending forward or rearward. A special screw 23 extends through each of these slots 23 as shown in FIG. 6 and has its forward end screwed into the holder 3, whereby the holder 3 is supported by the chassis 2 so as to be reciprocatingly movable forward or rearward relative to the chassis.

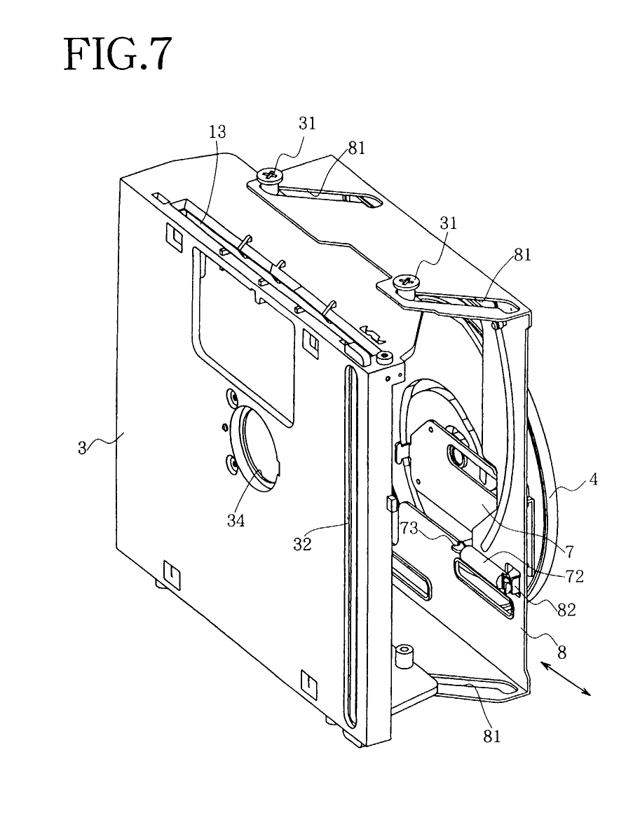

A cam slide 8 shown in FIGS. 7 and 18 is provided between the chassis 2 and the holder 3. The cam slide 8 is attached to the chassis 2 so as to be reciprocatingly movable horizontally laterally, i.e., leftward and rightward. The cam slide 8 has an upper wall and a lower wall, each of which has two cam slots 81, 81 extending in an oblique direction. The special screw 31 extends through the cam slot 81 and has its forward end screwed into the holder 3 as stated above. Accordingly, when the cam slide 8 is driven leftward and rightward, the holder 3 is reciprocatingly driven forward and rearward by the cam action of the cam slots 81 of the cam slide 8.

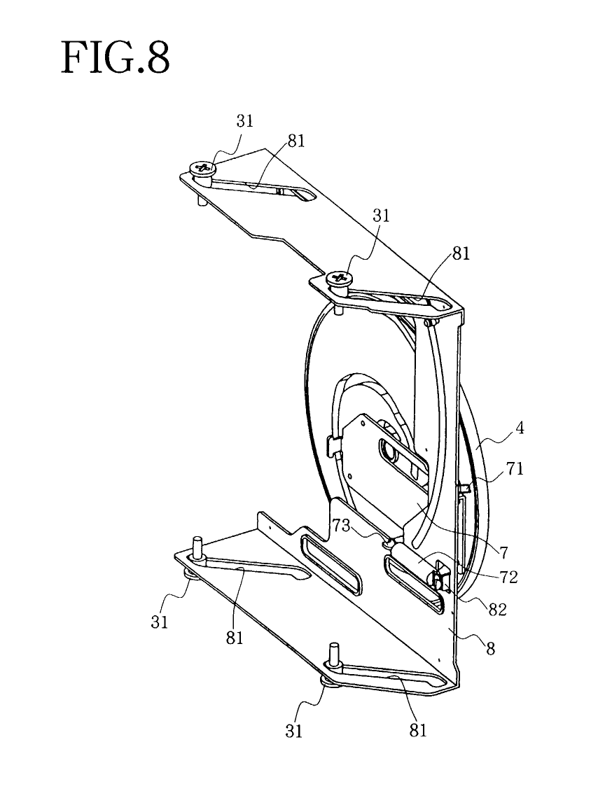

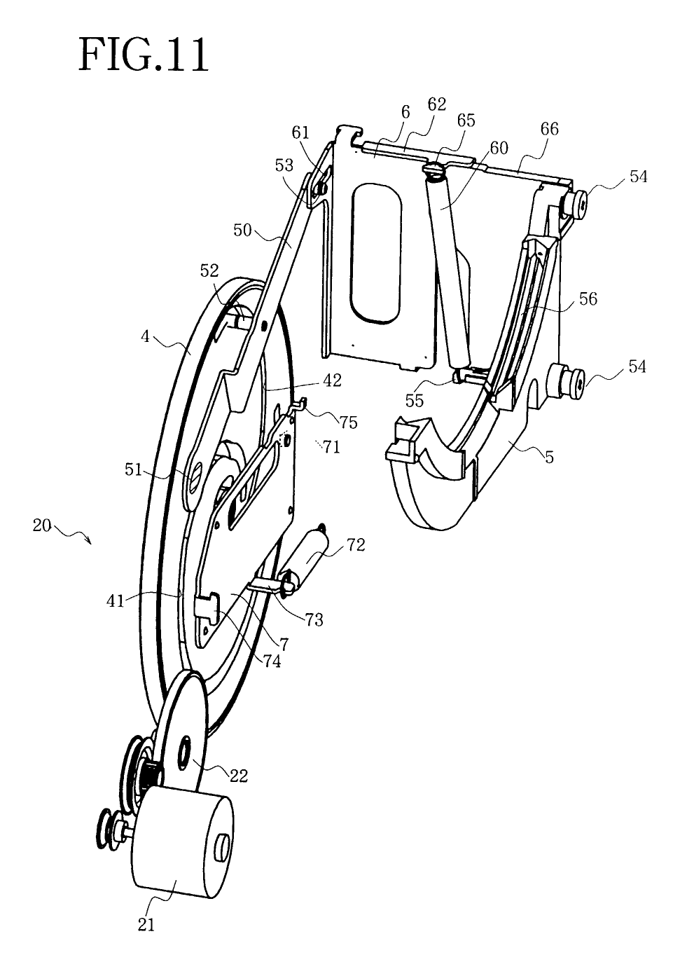

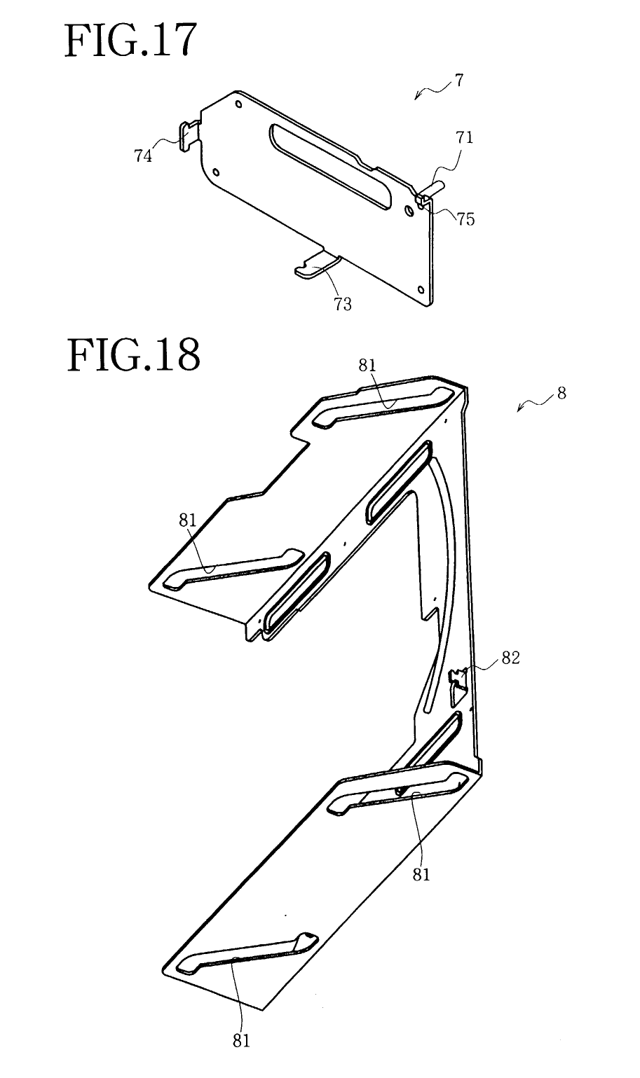

A holder drive slide 7 shown in FIGS. 8 and 17 and reciprocatingly movable along the chassis 2 is attached to the chassis 2 to face the cam gear 4. As shown in FIG. 17, projecting from the slide 7 are a cam follower 71, lugs 74, 75 and a spring retainer 73. The cam follower 71 is engaged in the first cam groove 41 of the cam gear 4 as seen in FIG. 11. Further the lugs 74, 75 are slidably engaged in guide slots (not shown) formed in the chassis, whereby the reciprocating movement of the holder drive slide 7 is guided as stated above. A connecting pin 72 has one end attached to the spring retainer 73 and the other end attached to a spring retainer 82 projecting from the cam slide 8 as shown in FIG. 8.

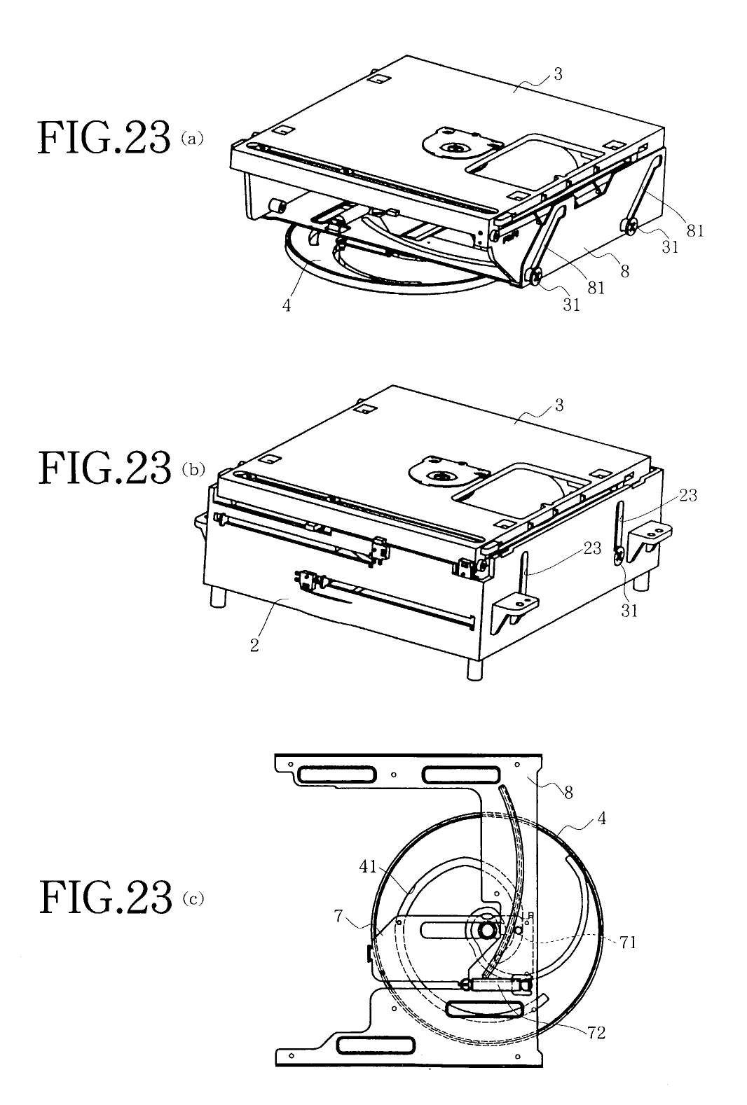

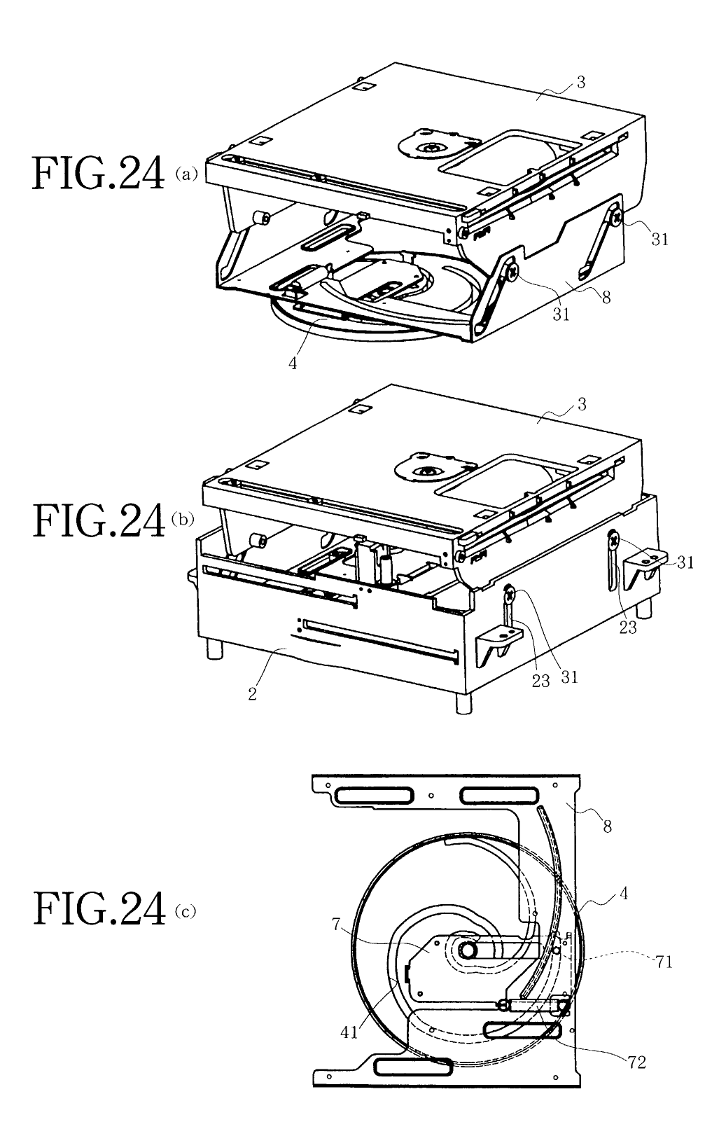

Accordingly, as shown in FIGS. 23(a) to 23(c) and FIGS. 24(a) to 24(c), when the rotation of the cam gear 4 reciprocatingly moves the holder drive slide 7 leftward and rightward, the cam slide 8 connected to the slide 7 by the spring 72 is reciprocatingly moved with the holder drive slide 7. The holder 3 is reciprocatingly driven by the cam action of the cam slots 81 of the cam slide 8.

Lifter Drive Mechanism

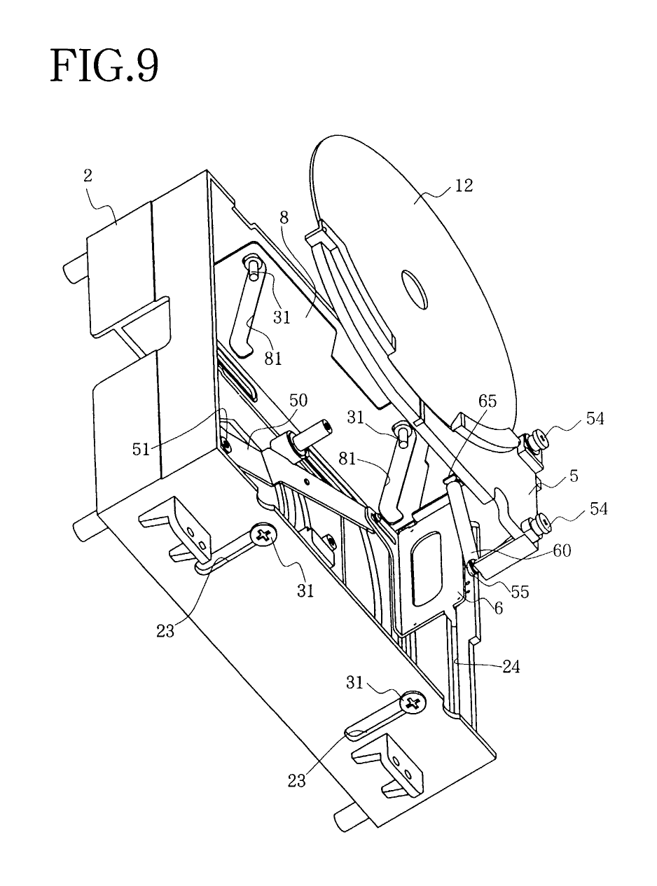

With reference to FIG. 9, a pair of upper and lower screws 54, 54 are screwed into the lifter 5, and the heads of the screws 54, 54 are engaged in a lifter guide slot 32 formed upward or downward in the holder 3 as shown in FIG. 2 to guide the upward and downward movement of the lifter 5.

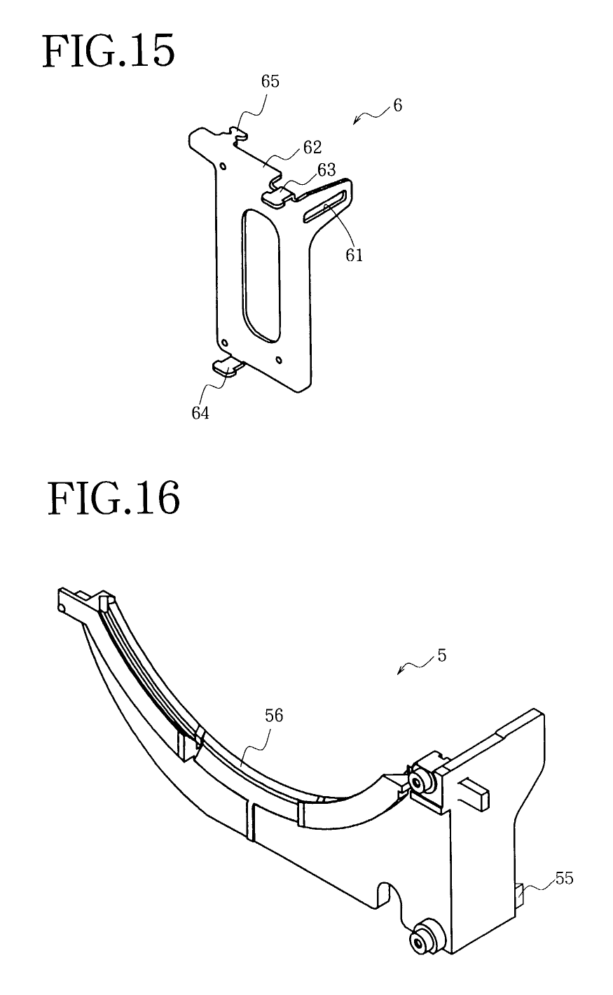

As shown in FIG. 9, a lifter drive slide 6 is upwardly and downwardly movably engaged with a side wall of the chassis 2. With reference to FIG. 15, the lifter drive slide 6 has a tongue 62, lugs 63, 64, a spring retainer 65 and a slit 61 extending forward or rearward. The lugs 63, 64 are slidably engaged in guide slots (not shown) formed in the side wall of the chassis for guiding the upward and rearward movement of the slide 6 as stated above.

As shown in FIG. 9, a connecting spring 60 extends between and is attached to a spring retainer 55 provided at a lower end portion of the lifter 5 and the spring retainer 65 of the lifter drive slide 6. The upper end face 66 of the lifter 5 is pressed into contact with the tongue 62 of the lifter drive slide 6 by the biasing force of the spring 60 as shown in FIG. 11. Further as shown in FIG. 9, the chassis 2 has mounted thereon a lifter drive lever 50 having a base end supported by a pivot 51 on the chassis 2 and pivotally movable in a vertical plane.

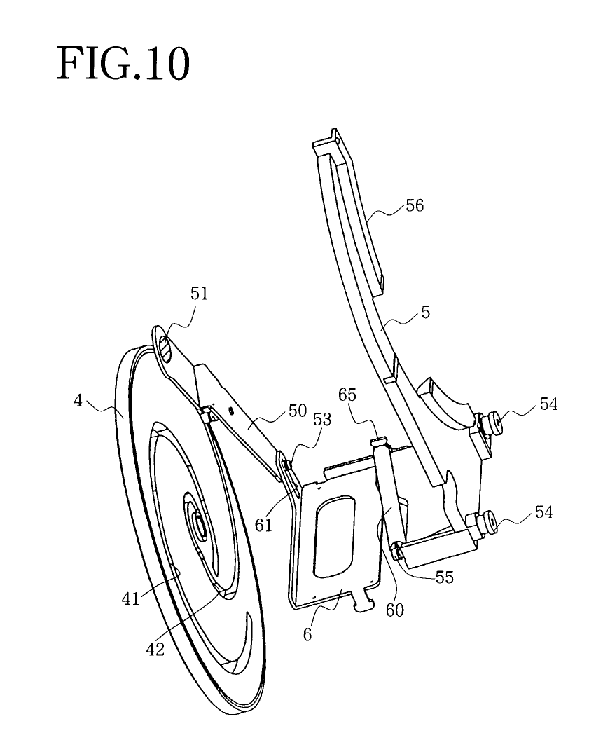

With reference to FIGS. 10 and 11, the lifter drive lever 50 is provided at an intermediate portion thereof with a cam follower 52 engaged in the second cam groove 42 of the cam gear 4. A drive pin 53 mounted on a forward end of the lever 50 is slidably fitted in the slit 61 of the lifter drive slide 6.

Accordingly, the rotation of the cam gear 4 pivotally moves the lifter drive lever 50, whereby the slide 6 is driven upward or downward. The upward or downward movement of the slide 6 moves the lifter 5 upward or downward.

The lifter drive slide 6 is mounted on the chassis 2, and the lifter 5 is provided on the holder 3, so that for example, in the course of forward movement of the holder 3, the slide 6 and the lifter 5 need to move horizontally relative to each other. However, since the slide 6 and the lifter 5 are interconnected by the spring 60, with the upper end face 66 of the lifter 5 merely in sliding contact with the tongue 62 of the slide 6, the connecting spring 60 stretches to permit the horizontal relative movement of the two components.

Prime Mover Mechanism

As shown in FIG. 11, the prime mover mechanism 20 comprises a motor 21 serving as a power source, and a reduction gear mechanism 22 comprising a gear and pulleys for coupling the output shaft of the motor 21 to the gear portion of the cam gear 4.

With reference to FIG. 14, the first cam groove 41 of the cam gear 4 has a cam groove portion A for holding the holder 3 in the completely opened position, a cam groove portion B for reciprocatingly driving the holder 3 between the open position and the closed position, and a cam groove portion C for holding the holder 3 in the closed position. The second cam groove 42 of the cam gear 4 has a cam groove portion D for holding the lifter 5 in an upper limit position (eject complete position), a cam groove portion E for vertically driving the lifter 5 between the upper limit position and a position (chucking position) immediate above and adjacent to a lower limit position, a cam groove portion F for holding the lifter 5 in the chucking position, a cam groove portion G for reciprocatingly driving the lifter 5 between the chucking position and the lower limit position (play position), and a cam groove portion H for holding the lifter in the lower limit position.

Chucking Mechanism

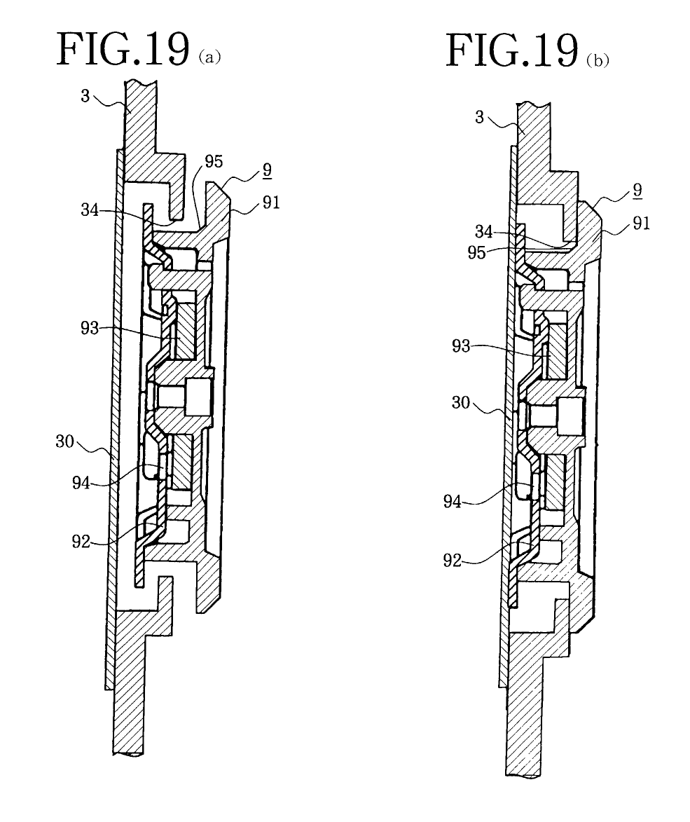

As shown in FIGS. 7 and 13, the holder 3 has an opening 34. An iron plate 30 is fixed to the surface of the holder to close the opening 34 as seen in FIG. 19. The holder 3 is provided with a chuck pulley assembly 9 inserted through the opening 34. The assembly 9 is rotatably disposed with slight play provided between the inner periphery of the holder defining the opening 34 and the assembly 9 radially of the assembly and with respect to the direction of axis of rotation thereof.

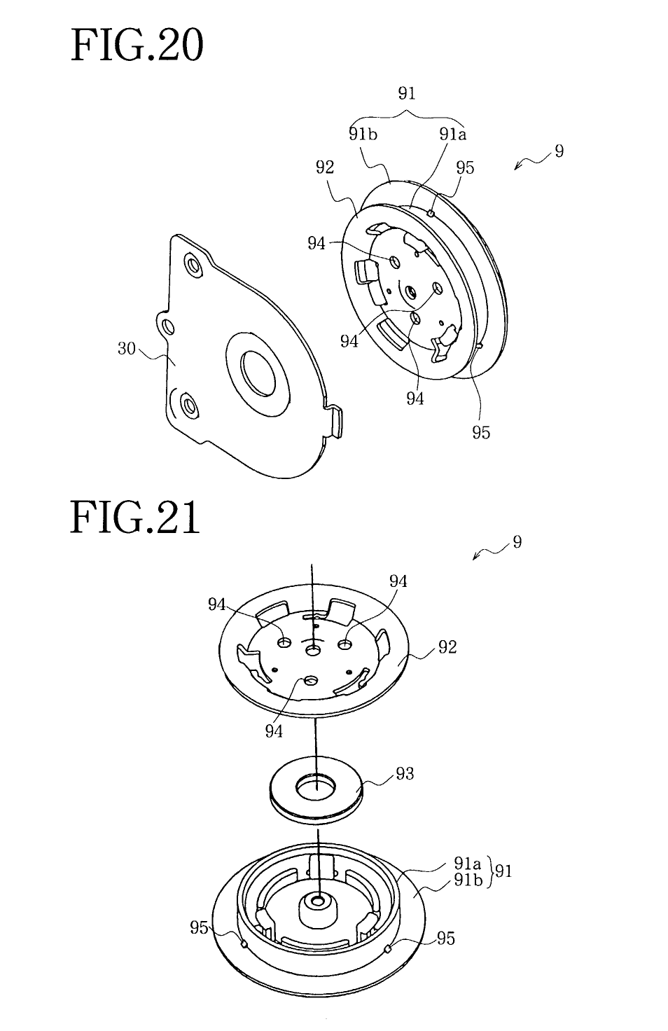

With reference to FIG. 20, the chuck pulley assembly 9 comprises a chuck pulley 91 and a chuck disk 92 in engagement with each other. The chuck pulley 91 is an integrally molded article of resin comprising a hollow cylinder 91a and a disk 91b as shown in FIG. 21. The chuck disk 92 is in the form of an integral iron plate. An annular magnet 93 is held between the pulley 91 and the disk 92.

The chuck disk 92 has a plurality of through holes 94 opposed to the magnet 93 for lines of magnetic force emanating from the magnet 93 to leak through the holes 94 and to act on the iron plate 30 shown in FIG. 20. The chuck pulley 91 has a wedgelike rib 95 inclined with respect to the axis of rotation of the pulley 91 and provided at each of a plurality of locations on both the cylinder 91a and the disk 91b. The diameter of a circle circumscribing the ribs 95 is equal to the inside diameter of the holder opening 34 as shown in FIG. 19.

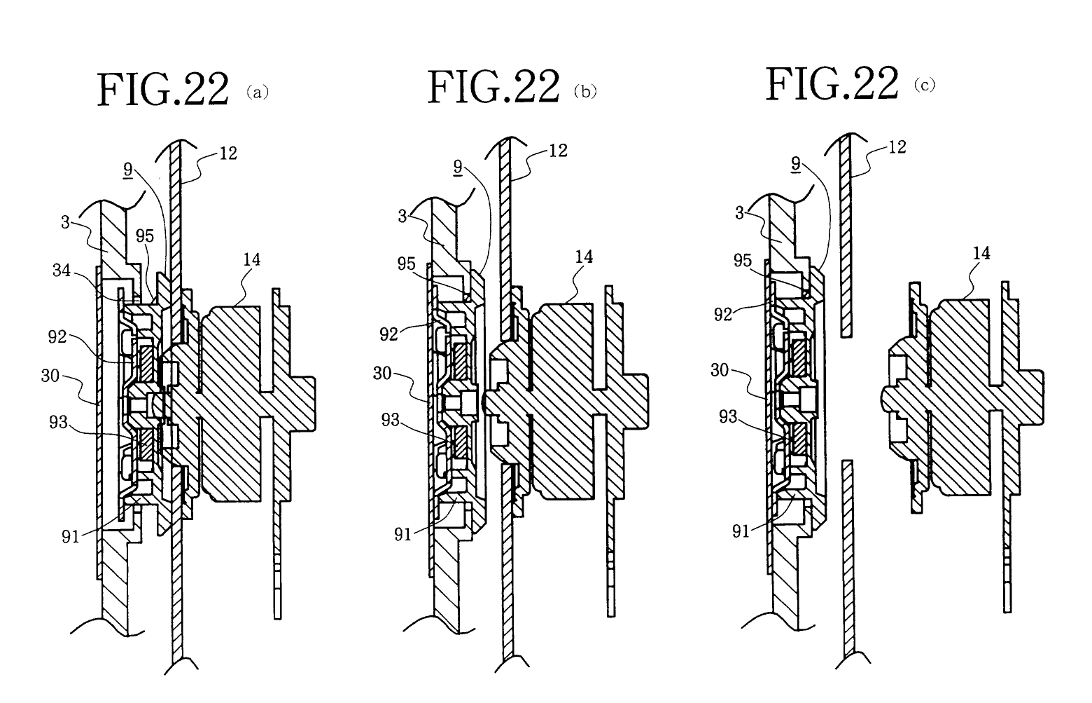

When the holder 3 is retracted to a chucking position as seen in FIG. 22(a), the magnetic force of the magnet 93 of the assembly 9 acts more intensely on the metal portion of the turntable 14 than on the iron plate 30, causing the turntable 14 to attract the assembly 9. As a result, the chuck pulley assembly 9 is shifted away from the iron plate 30 of the holder 3 and rendered free to rotate with slight play provided between the holder 3 and the assembly 9 radially of the assembly and with respect to the direction of axis of rotation thereof.

The assembly 9 in this state presses the disk 12 against the turntable 14 with the magnetic force of the magnet 93, whereby the disk 12 is held between the assembly 9 and the turntable 14. When the turntable 14 is rotated, therefore, the disk 12 and the assembly 9 rotate with the turntable 14, whereby signals can be reproduced from the disk 12.

When the holder 3 is moved away from the turntable 14 as seen in FIG. 22(b) so as to discharge the disk 12 after the reproduction of signals, the movement of the holder 3 moves the assembly 9 away from the turntable 14. Consequently, the magnetic force of the magnet 93 of the assembly 9 acts more intensely on the iron plate 30 than on the turntable 14, causing the iron plate 30 to attract the assembly 9. At this time, the slanting faces of the ribs 95 on the assembly 9 come into sliding contact with the inner periphery of the holder 3 defining the opening 34, and the axis of rotation of the assembly 9 is aligned with the axis of rotation of the turntable 14 by the aligning action of the slanting faces. The assembly 9 in this state is held to the holder 3.

When the holder 3 is thereafter moved further away from the turntable 14 as shown in FIG. 22(c), the disk 12 is released from the turntable 14 with this movement of the holder 3 and received by the lifter 5 waiting below the disk. Since the assembly 9 is held to the holder 3 at a position away from the disk 12 at this time, there is no likelihood of the disk 12 interfering with the assembly 9.

The assembly 9 is held at the position, as aligned with the turntable 14, so that when the assembly 9 is thereafter attracted by the turntable 14 as shown in FIG. 22(a) by a chucking movement, the assembly 9 in a vertical posture horizontally moves toward the turntable 14 without coming into sliding contact with the opening-defining inner periphery of the holder 3, and is engaged with the turntable 14 in this posture. Thus, a smooth chucking movement is realized.

Mode Changes

With reference to FIGS. 2 and 3, the chassis 2 has mounted thereon a closed position switch 25 for detecting the holder 3 as brought to the closed position, and a chuck switch 26 for detecting the lifter 5 as brought to the lower limit position. The holder 3 is provided with an eject switch 33 for detecting the lifter 5 as brought to the upper limit position. Connected to these switches 25, 26, 33 are input ports of an unillustrated microcomputer. The rotation of the motor 21 of the prime mover mechanism 20 is controlled based on the on-off action of the switches.

FIGS. 25 to 29 show operation mode changes from the completion of disk ejection to playing state. In the state of completion of disk ejection shown in FIG. 25, the holder 3 is in the forwardly projecting position, and the lifter 5 is in its upper limit position. When a disk 12 inserted into the disk inlet 13 of the holder 3 is released from the hand, the disk 12 slightly falls under gravity and is thereafter received by the lifter 5.

When the disk 12 in this state is slightly pushed down, the lifter 5 descends against the connecting spring 60 shown in FIG. 11, thereby turning off the eject switch 33. As a result, the motor 21 of the prime mover mechanism 20 is initiated into operation to drive the cam gear 4 counterclockwise. The rotation of the cam gear 4 turns the lifter drive lever 50 clockwise, lowering the lifter drive slide 6 with this movement. Furthermore, the lifter 5 lowers with the descent of the lifter drive slide 6, drawing the disk 12 on the lifter 5 into the holder 3.

Even if an excessive force is applied to the disk 12 in pushing down the disk 12, the force is absorbed by the expansion of the connecting spring 60. This obviates the likelihood of the disk 12 deforming or the lifter drive mechanism becoming damaged.

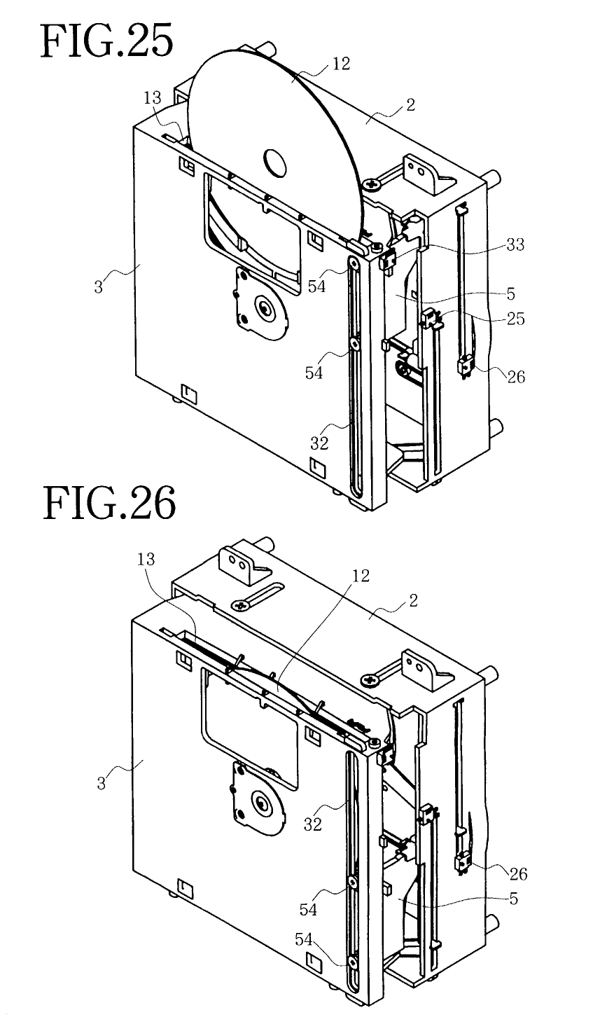

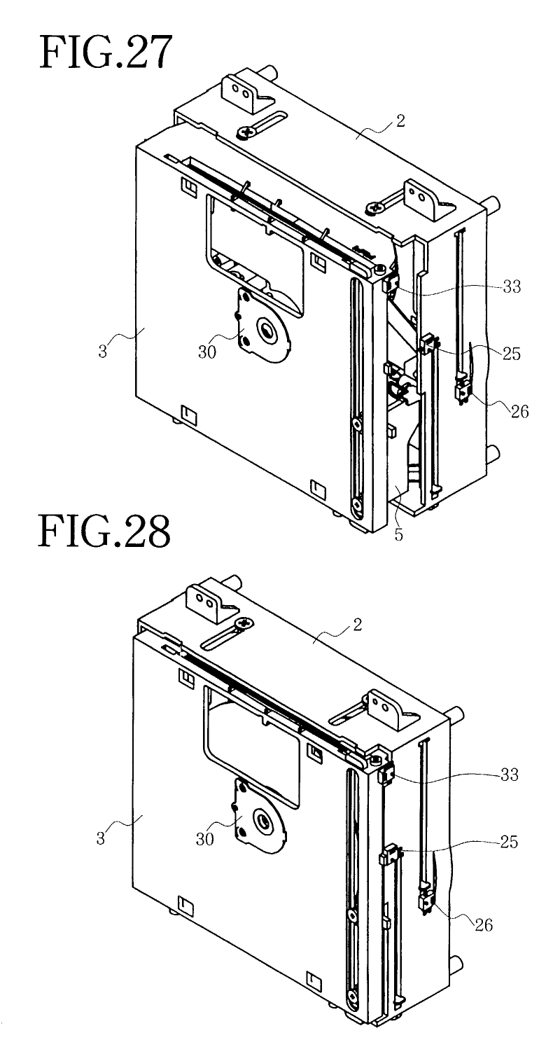

Further rotation of the cam gear 4 from the state of FIG. 26 allows the lifter 5 to continue the descent as shown in FIG. 27, also initiating the holder 3 into retraction from the open position toward the closed position. In the chucking completed state shown in FIG. 28, the lifter 5 descends to the chucking position for the holder 3 to reach the closed position. This turns on the closed position switch 25 to detect the completion of closing of the holder 3.

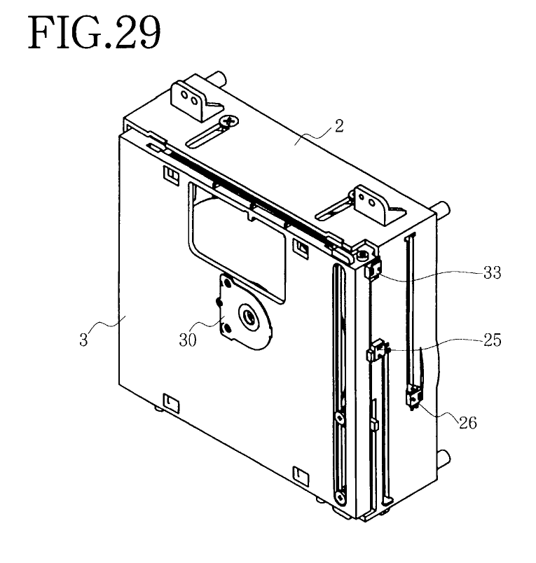

Subsequently in the playing state shown in FIG. 29, the lifter 5 further descends and is released from the chucked disk 12, whereupon the chuck switch 26 is turned on. The turntable 14 is driven for the signal reproduction unit 15 to start to play back the disk 12.

When the disk 12 is to be ejected after the playback of the disk 12, the motor 21 of the prime mover mechanism 20 drives the cam gear 4 clockwise, whereby the lifter 5 is moved up to the chucking position as shown in FIG. 28 to receive the disk 12. Subsequently, the holder 3 starts to move from the closed position toward the open position as shown in FIG. 27, and the lifter 5 then starts to move upward. The lifter 5 reaches the open position as shown in FIG. 26. The lifter 5 further continues to ascend and eventually reaches the upper limit position as shown in FIG. 25 to completely eject the disk 12.

The disk player 11 of the present invention is installed in the cabinet 16 of the television receiver 1, as exposed from the front panel 17 of the cabinet as shown in FIGS. 1(a) and 1(b). The holder 3 is reciprocatingly movable horizontally between the open position [FIG. 1(b)] wherein the disk inlet 13 is advanced forward beyond the front panel 17 and the closed position [FIG. 1(a)] wherein the disk inlet 13 is retracted rearwardly of the front panel 17, thus moving the inlet 13 outward beyond the panel 17 or retracting the inlet 13 rearwardly of the panel. Accordingly, other mechanisms, if provided above the disk player 11 inside the cabinet 16, will cause no trouble to the operation of the player 11. The disk player 11 can therefore be disposed in the central portion or lower portion of the front panel 17.

Because the disk 12 is accommodated in a vertical posture parallel to the front panel 17 within the holder 3, the depthwise dimension of the cabinet 16 is free of the limitation to be imposed by the diameter of the disk 12. The cabinet 16 can therefore be made thin. The lifter drive mechanism comprises a lifter drive slide 6 and a lifter 5 which are merely interconnected by a spring 60, so that the mechanism is simple in construction, and the damage to the disk 12 or lifter drive mechanism is avoidable, while the lifter drive slide 6 and the lifter 5 can be made movable relative to each other.

The disk chucking mechanism chucks the disk 12 retained in the holder 3 and releases the disk from the chuck merely by reciprocatingly driving the holder 3 toward and away from the turntable 14 relative thereto, and is therefore very simple in construction. Further in chucking the disk, the chuck pulley assembly 9 engages with the turntable 14, with the axis of rotation of the assembly 9 in alignment with the axis of rotation of the turntable 14. This realizes reliable engagement.

The disk player and the television receiver of the present invention are not limited to the foregoing embodiment in construction but can be modified variously by one skilled in the art without departing from the spirit of the invention as set forth in the appended claims.

What is claimed is:

1. A disk player for reproducing signals recorded on disks, the disk player comprising:
a turntable (14) having a horizontal rotation spindle,
a signal reproduction unit (15) for reproducing signals from the disk (12) as placed in a vertical posture on the turntable (14),
a holder (3) having an upwardly open disk inlet (13) and movable toward or away from the turntable (14) while holding therein the disk (12) inserted in a vertical posture through the inlet (13),
a holder drive mechanism for reciprocatingly driving the holder (3) toward and away from the turntable;
a lifter (5) disposed inside the holder (3) and adapted to support the disk (12) in the vertical posture as inserted through the inlet (13),
a lifter drive mechanism for upwardly or downwardly driving the lifter (5) inside the holder (3), and
a prime mover mechanism (20) including a motor (21) as a power source for transmitting power to the holder drive mechanism and to the lifter drive mechanism.

2. A disk player according to claim 1 wherein the holder (3) is provided with a mechanism for chucking the disk (12) between the chucking mechanism and the turntable (14).

3. A disk player according to claim 1 wherein the prime mover mechanism (20) comprises a cam gear (4) having a first and a second cam groove (41)(42), and the motor (21) for rotatingly driving the cam gear (4), the first cam groove (41) of the cam gear (4) having engaged therein a cam follower (71) provided on an input portion of the holder drive mechanism, the second cam groove (42) of the cam gear (4) having engaged therein a cam follower (52) provided on an input portion of the lifter drive mechanism.

4. A television receiver having a disk player provided in a cabinet and exposed from a front panel (17) of the cabinet (16), the television receiver comprising:
a turntable (14) for rotatingly driving the disk (12) in a vertical posture parallel to the front panel (17),
a signal reproduction unit (15) for reproducing signals from the disk (12) as placed in the vertical posture on the turntable (14),
a holder (3) having an upwardly open disk inlet (13) and movable toward or away from the turntable (14) while holding therein the disk (12) inserted in the vertical posture through the inlet (13), the holder (3) being movable between an open position where the disk inlet (13) is advanced forward beyond the front panel (17) and a closed position where the inlet (13) is retracted rearwardly of the front panel (17),
a holder drive mechanism for reciprocatingly driving the holder (3) toward and away from the turntable;
a lifter (5) disposed inside the holder (3) and adapted to support the disk (12) in the vertical posture as inserted through the inlet (13),
a lifter drive mechanism for upwardly or downwardly driving the lifter (5) inside the holder (3), and
a prime mover mechanism (20) including a motor (21) as a power source for transmitting power to the holder drive mechanism and to the lifter drive mechanism.

5. A disk player for reproducing signals recorded on disks, the disk player comprising:
a chassis (2) provided with a turntable (14) and a signal reproduction unit (15),
a holder (3) having an upwardly open disk inlet (13) and reciprocatingly horizontally movably supported by the chassis (2), the holder (3) being movable toward or away from the turntable (14),
a holder drive mechanism for reciprocatingly driving the holder (3) toward and away from the turntable;
a lifter (5) disposed inside the holder (3) upwardly or downwardly movably and adapted to support the disk (12) in a vertical posture as inserted through the inlet (13), and
a lifter drive mechanism for upwardly or downwardly driving the lifter (5) inside the holder (3), the lifter drive mechanism comprising a lifter drive slide (6) upwardly or downwardly drivable by a prime mover mechanism (20) provided on the chassis (2), and a spring (60) connecting an end portion of the lifter drive slide (6) to an end portion of the lifter (5).

6. A disk player according to claim 5 wherein the end portion of the lifter drive slide (6) and the end portion of the lifter (5) are movable relative to each other along the direction of movement of the holder (3) in sliding contact with each other and are pressed into contact with each other by the biasing force of the connecting spring (60).

7. A disk player according to claim 5 wherein the holder (3) is provided with a mechanism for chucking the disk (12) between the chucking mechanism and the turntable (14).

8. A disk player according to claim 5 wherein the prime mover mechanism (20) comprises a cam gear (4) having a first and a second cam groove (41)(42), and the motor (21) for rotatingly driving the cam gear (4), the first cam groove (41) of the cam gear (4) having engaged therein a cam follower (71) provided on an input portion of the holder drive mechanism, the second cam groove (42) of the cam gear (4) having engaged therein a cam follower (52) provided on an input portion of the lifter drive mechanism.

9. A disk chucking mechanism for chucking a disk (12) on a turntable (14) for use in a disk player for reproducing signals recorded on the disk, the disk chucking mechanism comprising:
a holder (3) movable toward or away from the turntable (14) relative thereto while holding the disk (12) therein,
a chuck pulley assembly (9) provided on, and inserted through an opening (34) in, the holder (3) for holding the disk (12) between the assembly and the turntable (14), and
a metal member attached to the holder (3) and opposed to the chuck pulley assembly (9),
the chuck pulley assembly (9) comprising a resin chuck pulley (91) engageable with the turntable (14), a metal chuck disk (92) opposed to the metal member and a magnet (93) provided between the chuck pulley (91) and the chuck disk (92), the chuck disk (92) having a plurality of through holes (94) formed therein for causing lines of magnetic force emanating from the magnet (93) to leak therethrough toward the metal member.

10. A disk chucking mechanism according to claim 9 wherein specified play is provided between an inner periphery of the holder (3) defining the opening (34) and an outer periphery of the chuck pulley assembly (9) radially of the assembly (9) and with respect to the direction of axis of rotation thereof, and the chuck pulley assembly (9) has guide faces slidable in contact with the opening-defining inner periphery of the holder (3) when moved toward the holder (3) to align a center axis of the assembly (9) with a center axis of the turntable (14).

11. A disk chucking mechanism according to claim 9 wherein the turntable (14) is mounted on a chassis (2) with a rotation spindle thereof positioned horizontally, and the holder (3) has an upwardly open disk inlet (13) and is supported by the chassis (2) so as to be movable toward or away from the turntable (14), the holder (3) being reciprocatingly drivable by a holder drive mechanism.

12. A disk chucking mechanism according to claim 11 wherein a lifter (5) is disposed inside the holder (3) for supporting the disk (12) and is drivable upward or downward by a lifter drive mechanism.

13. A disk chucking mechanism for chucking a disk (12) on a turntable (14) for use in a disk player for reproducing signals recorded on the disk, the disk chucking mechanism comprising:
a holder (3) movable toward or away from the turntable (14) relative thereto while holding the disk (12) therein, and
a chuck pulley (91) provided on, and inserted through an opening (34) in, the holder (3) for holding the disk (12) between the pulley and the turntable (14),
specified play being provided between an inner periphery of the holder (3) defining the opening (34) and an outer periphery of the chuck pulley (91) radially of the pulley (91) and with respect to the direction of axis of rotation thereof, the chuck pulley (91) having guide faces slidable in contact with the opening-defining inner periphery of the holder (3) when moved toward the holder (3) to align a center axis of the pulley (91) with a center axis of the turntable (14).

14. A disk chucking mechanism according to claim 13 wherein the chuck pulley (91) is made of a resin, and a metal chuck disk (92) is attached to the chuck pulley (91) coaxially therewith, with a magnet (93) disposed between the chuck pulley (91) and the chuck disk (92), the chuck disk (92) having a plurality of through holes (94) formed therein for causing lines of magnetic force emanating from the magnet (93) to leak therethrough to the outside, the holder (3) being provided with a metal member opposed to the chuck disk (92).

15. A disk chucking mechanism according to claim 13 wherein the turntable (14) is mounted on a chassis (2) with a rotation spindle thereof positioned horizontally, and the holder (3) has an upwardly open disk inlet (13) and is supported by the chassis (2) so as to be movable toward or away from the turntable (14), the holder (3) being reciprocatingly drivable by a holder drive mechanism.

16. A disk chucking mechanism according to claim 15 wherein a lifter (5) is disposed inside the holder (3) for supporting the disk (12) and is drivable upward or downward by a lifter drive mechanism.
